(19) United States
(12) Patent Application Publication
(10) Pub. No.: US 2005/0031916 A1
(43) Pub. Date: Feb. 10, 2005

(54) Electronic apparatus, fuel tank unit, and method of controlling a power supply for the electronic apparatus

(75) Inventor: Akihiro Ozeki, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/806,334

(22) Filed: Mar. 23, 2004

(30) Foreign Application Priority Data
Mar. 25, 2003 (JP) 2003-083630

(51) Int. Cl. H01M 8/04

(52) U.S. Cl. 429/13; 429/34

(57) ABSTRACT

The body of an electronic apparatus houses a DMFC unit which produces energy by causing methanol supplied as fuel to react with oxygen. The body further houses a cartridge fuel tank which holds methanol, fuel for the DMFC unit. Furthermore, on the body, there is provided an attachment (connector unit) to which an external fuel tank unit holding a large amount of methanol, fuel for the DMFC unit, can be connected. In the external fuel tank unit, two fuel tanks of the same shape are provided so as to be installed and removed freely.

### CROSS-REFERENCE TO RELATED APPLICATIONS

This application is based upon and claims the benefit of priority from prior Japanese Patent Application No. 2003-083630, filed Mar. 25, 2003, the entire contents of which are incorporated herein by reference.

### BACKGROUND OF THE INVENTION

1. Field of the Invention

The present invention relates to an electronic apparatus having a fuel cell built into its body, a fuel tank unit connectable to the surrounding wall of a housing for the body, and a method of controlling a power supply for the apparatus.

2. Description of the Related Art

In recent years, various types of battery-powered portable electronic apparatuses, such as portable information terminals called personal digital assistants (PDAs) or digital cameras, have been developed and become widely used.

In addition, environmental problems have lately attracted considerable attention, and environment-friendly batteries are now being actively developed. One well-known battery of this type is a direct methanol fuel cell (hereinafter, referred to as a DMFC).

In the DMFC, methanol supplied as fuel reacts with oxygen, thereby producing electrical energy. The DMFC has a structure wherein an electrolyte sandwiched between two electrodes composed of porous metal or carbon (e.g., see Hironosuke Ikeda “All about Fuel Cells,” Nihonjitsugyo Publishing Co., Ltd, Aug. 20, 2001, pp. 216-217). Since DMFCs do not generate toxic substances, there is a strong demand that they be used in the above-mentioned electronic apparatus.

The possible quantity of power generation of the DMFC is proportional to the possible amount of fuel consumed. Therefore, to drive the apparatus for a long time, it is necessary to install a fuel tank with a large capacity. Accordingly, when a DMFC.is built into, for example, a notebook personal computer, the following problem arises: as the fuel tank becomes larger in size, this results in an increase in the volume of the body of the personal computer.

### BRIEF SUMMARY OF THE INVENTION

According to an embodiment of the present invention, an electronic apparatus comprises a body, a fuel cell which is built into the body, a first fuel tank which holds fuel for the fuel cell built into the body, and a second fuel tank which is removably provided to the body and which holds fuel for the fuel cell.

### BRIEF DESCRIPTION OF THE SEVERAL VIEWS OF THE DRAWING

The accompanying drawings, which are incorporated in and constitute a part of the specification, illustrate a presently preferred embodiment of the invention, and together with the general description given above and the detailed description of the preferred embodiment given below, serve to explain the principles of the invention.

FIG. 1 shows an outward appearance of an electronic apparatus according to an embodiment of the present invention;

FIG. 2 shows a method of installing an external fuel tank unit for the electronic apparatus of the embodiment;

FIG. 3 shows a schematic configuration of the electronic apparatus and external fuel tank unit according to the embodiment;

FIG. 4 is a diagram to help explain the liquid supply route of fuel in the electronic apparatus and external fuel tank unit according to the embodiment;

FIG. 5 is a first diagram of a power supply management setting screen displayed by the power supply management utility operating on the electronic apparatus of the embodiment;

FIG. 6 is a second diagram of the power supply management setting screen displayed by the power supply management utility operating on the electronic apparatus of the embodiment; and

FIG. 7 is a flowchart to help explain the procedure for power supply control executed by the electronic apparatus of the embodiment.

### DETAILED DESCRIPTION OF THE INVENTION

Hereinafter, referring to the accompanying drawings, an embodiment of the present invention will be explained.

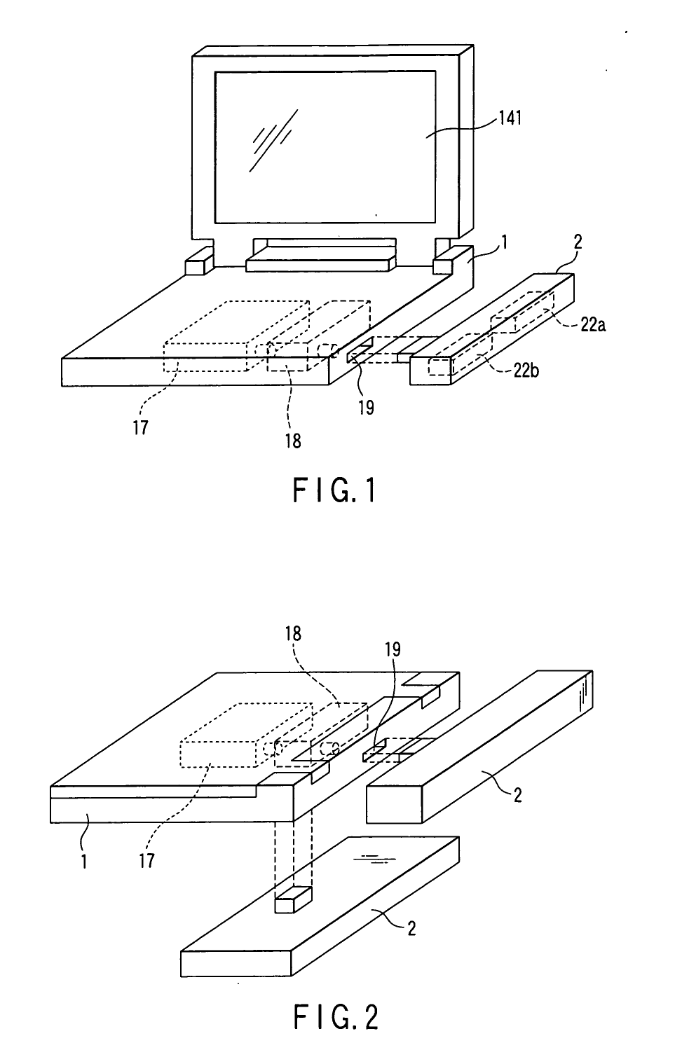

FIG. 1 shows an outward appearance of an electronic apparatus according to an embodiment of the present invention.

The electronic apparatus 1 is an easy-to-carry notebook personal computer. On the inside face of a cover section mounted on the body section so as to open and close freely, there is provided a liquid crystal display (LCD) 141. The body section houses a DMFC unit 17 which causes methanol supplied as fuel to react with oxygen, thereby producing electrical energy. It further houses a cartridge fuel tank 18 which holds methanol, fuel for the DMFC unit 17.

The body section is further provided with an attachment (connector section) 19 to which an external fuel tank unit 2 for holding a large amount of methanol, fuel for the DMFC unit 17, can be connected as needed. The external fuel tank unit 2 is designed so as to enable fuel tanks 22a, 22b of the same shape to be installed and removed freely.

Specifically, the electronic apparatus 1 not only houses the DMFC unit 17 but also enables the external fuel tank unit 2 to be externally connected. This configuration makes it unnecessary to install a fuel tank with a large capacity in the body section. The configuration further enables the external fuel tank unit 2 to be connected as needed, which makes it possible for the DMFC unit 17 to generate electricity for a long time and therefore to drive the electronic apparatus 1 for a long time. Eliminating the need to install a fuel tank with a large capacity in the body section means suppressing an increase in the volume of the body section of the electronic apparatus 1.

For example, in the case of a mobile PC having a rating of about 20 W, when the PC has a fuel tank with a capacity of about 50 cc in it, this makes it possible to drive the PC for about 2 to 3 hours. The capability of driving for 2 to 3 hours is sufficient for normal use, but it is insufficient when the user wants to drive the PC from the battery all day, for example, on a business trip. In such a case, adding an external fuel tank unit 2 with a capacity of, for example, 250 cc (the fuel tanks 22a, 22b each having a capacity of about 125 cc) guarantees about 13 to 16 hours of driving, which enables the PC to operate for a long time without an AC adapter or battery.

Since the external fuel tank 2 enables the fuel tanks 22a, 22b to be installed and removed freely, this makes it possible to use the tank unit 2 according to the situation in such a manner that only one of them is installed in a case and both of them are installed in another case.

While in FIG. 1, the external fuel tank unit 2 is installed on the left side of the housing of the body of the electronic apparatus 1, the present invention is not limited to this. For instance, the external fuel tank unit 2 may be installed on the back or on the underside of the housing of the body of the electronic apparatus 1. Alternatively, two or more units of the external fuel tank unit 2 may be provided at the same time.

While in the above explanation, the fuel tank 18 housed in the body has a capacity of about 50 cc and the fuel tanks 22a, 22b installed in the external fuel tank unit 2 each have a capacity of about 125 cc, more than twice the capacity of the fuel tank 18, the external fuel tank unit 2 may have two or more units of the fuel tank 18 installed in it. This is suitable, for example, when fuel tanks are standardized.

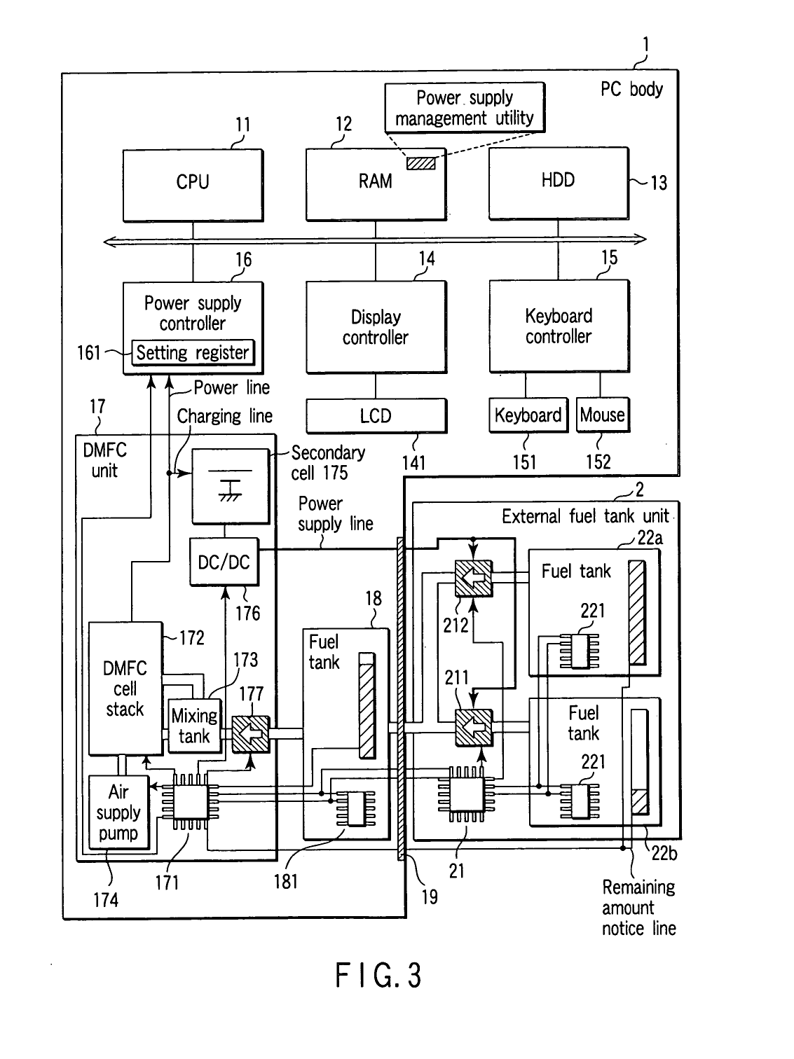

FIG. 3 shows a schematic configuration of the electronic apparatus 1 and external fuel tank unit 2.

As shown in FIG. 3, in the electronic apparatus 1, a CPU 11, a RAM 12, an HDD 13, a display controller 14, a keyboard controller 15, and a power supply controller 16 are connected to a system bus. The electronic apparatus 1 houses not only the DMFC unit 17 as a battery but also the fuel tank 18 that holds methanol, fuel for the DMFC unit 17. The electronic apparatus 1 is further provided with the connector section 19 which enables the external fuel tank unit 2 to be externally connected as needed.

The CPU 11, which supervises control of the operation of the entire electronic apparatus 1, executes various types of programs, including an operating system, basic input/output system (BIOS), utility software, and application software stored in the RAM 12. Power supply management utility (explained later) is one of a plurality of utility software programs.

The RAM 12 is a storage medium which stores various programs executed by the CPU 11 and.various types of data used in those programs. The HDD 131 is a nonvolatile storage medium which stores various programs and various types of data in large amounts. The programs stored in the HDD 13 are read and copied into the RAM 12 under the control of the CPU 11 and thereafter are executed by the CPU 11.

The display controller 14, which is a device that handles the output side of a user interface provided by the electronic apparatus 1, performs control of the screen data processed by the CPU 11 so as to display the data on the LCD 141. The keyboard controller 15, which is a device that handles the input side of the user interface provided by the electronic apparatus 1, digitizes the operation of the keyboard 151 or mouse 152 and transmits the result via an internal register to the CPU 11.

The power supply controller 16, which supplies electrical power to each section of the electronic apparatus 1, provides driving control of the DMFC unit 17. In addition, the power supply controller 16, which includes a setting register for making various settings related to the use of a plurality of fuel tanks, updates the setting values under the control of the power supply management utility. The setting register 161 also stores status information indicating the states of the DMFC unit 17 and external fuel tank unit 2. Referring to the status information, the power supply management utility can know the states of the DMFC unit 17 and the fuel cell tank unit 2.

The DMFC unit 17 driven by the power supply controller 16 includes a fuel cell unit built-in microcomputer 171 (hereinafter, just referred to as the microcomputer 171), a DMFC cell stack 172, a secondary cell 175, and a DC-to-DC converter 176.

The microcomputer 171, which supervises control of the operation of the entire DMFC unit 17, controls the amount of fuel fed from the fuel tank 18 to the DMFC cell stack 172 by means of a liquid supply pump. Furthermore, the microcomputer 171 reads the remaining amount of fuel in the fuel tank 18 from an E2PROM 181 built into the fuel tank 18, and subtracts the remaining amount according to the situation of use. In addition, the microcomputer 171 has the function of communicating with the power supply controller 16 and an external fuel tank unit microcomputer 21 explained later.

The DMFC cell stack 172 causes methanol held in the fuel tank 18 to react with oxygen fed from an air supply pump 174, thereby producing electric power to operate the electric apparatus 1. A liquid supply pump 177 feeds methanol from the fuel tank 18 to a mixing tank 173. In the mixing tank 173, the methanol fed from the fuel tank 18 and the water produced as a result of chemical reaction at the DMFC stack 172 are mixed, thereby diluting the methanol to a concentration of about 3% to 6%. The diluted methanol is sent from the mixing tank 173 to the DMFC cell stack 172. In the DMFC cell stack 172, the methanol reacts with the air fed by the air supply pump 174, thereby producing electrical energy. A part of the electricity generated at this time is also supplied to the secondary cell 175. As a result, the secondary cell 175 is charged.

The internal secondary cell 175, which is a lithium ion cell that can be charged and discharged repeatedly, accumulates and outputs electric power needed for the liquid supply pump to operate. The DC-to-DC converter 176 is for converting the power from the secondary cell 175 to a voltage suitable for the liquid supply pumps 211, 212.

The fuel tank 18, which is in the shape of a cartridge that can be housed in the body of the electronic apparatus 1, has the E2PROM 181 accessible from the microcomputer 171. When the E2PROM 18 is unused, the remaining amount of the full capacity is recorded in it.

The external fuel tank unit 2 externally connected via the connector section 19 has the external fuel tank unit microcomputer 21 (hereinafter, just referred to as the microcomputer 21). The microcomputer 21 drives the liquid supply pumps 211, 212, thereby feeding fuel from the fuel tanks 22a, 22b installed in a detachable manner to the fuel tank 18 in the body. Furthermore, the microcomputer 21 reads the remaining amount of fuel in each of the fuel tanks 22a, 22b from the E2PROM 221, and subtracts the remaining amount according to the situation of use. In addition, the microcomputer 21 has the function of communicating with the microcomputer 171 of the DMFC unit 17.

Each of the fuel tanks 22a, 22b, which is in the shape of a cartridge installable in the external fuel tank unit 2, has an E2PROM 221 accessible from the microcomputer 21 as described above. When the E2PROM 221 is unused, the remaining amount of the full capacity is recorded in it.

Specifically, the remaining amount of fuel in each of the fuel tanks 22a, 22b installed in the external fuel cell unit 2 is recorded into the corresponding E2PROM 221 under the control of the microcomputer 21 and then transmitted to the microcomputer 171 in communication. The remaining amount of fuel in the fuel tank 18 housed in the body of the electronic apparatus 1 is recorded into the E2PROM 181 under the control of the microcomputer 171. The microcomputer 171 transmits the remaining amount of fuel in each of the fuel tanks 22a, 22b obtained in communication with the microcomputer 21 and the remaining amount of fuel in the fuel tank 18 recorded in the E2PROM 181 to the power supply controller 16 in communication. Receiving the amounts, the power supply controller 16 stores the values into the setting register 161. This enables the power supply management utility to recognize comprehensively the remaining amount of fuel usable by the DMFC unit 17.

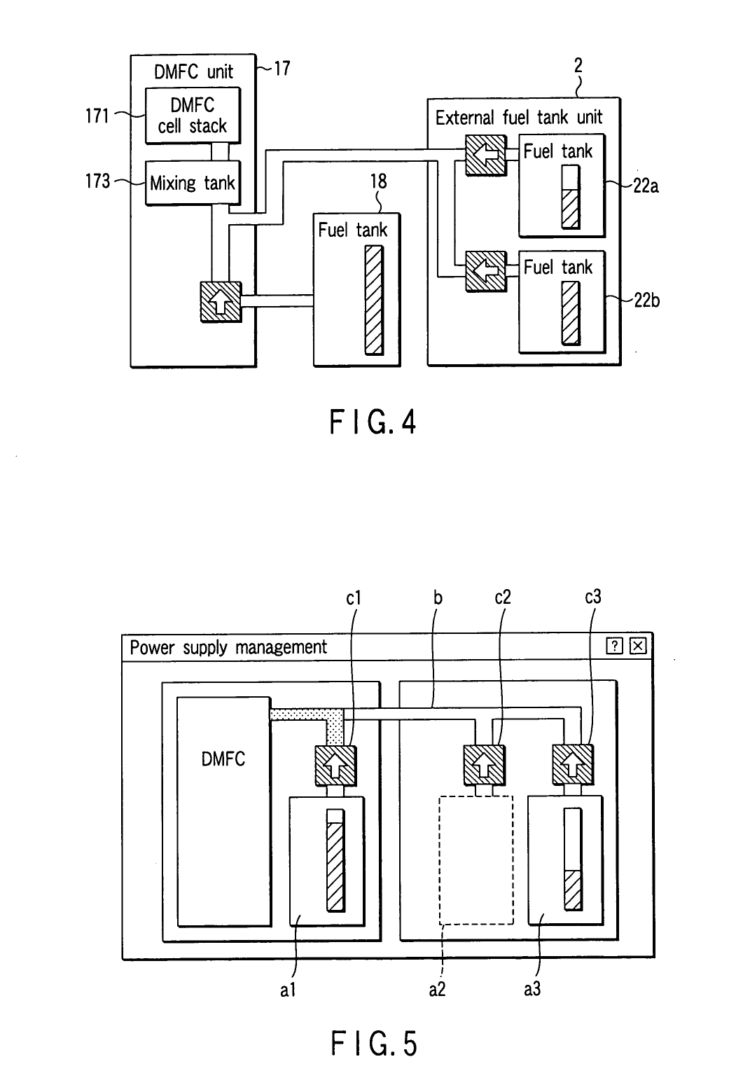

In FIG. 3, the fuel in the fuel tanks 22a, 22b installed in the external fuel tank unit 2 has been sent by the liquid supply pumps 211, 212 to the fuel tank 18 housed in the body of the electronic apparatus 1. Alternatively, for example, as shown in FIG. 4, the fuel in the fuel tanks 22a, 22b may be fed to the mixing tank 173 without letting the fuel pass through the fuel tank 18.

As described above, the power supply management utility which recognizes comprehensively the remaining amount of fuel usable by the DMFC unit 17 displays a power supply management setting screen as shown in FIG. 5 on the LCD 141 according to the user's request. The setting screen first displays the present using states of the individual fuel tanks 18, 22a, 22b.

In FIG. 5, a1 to a3 indicate the fuel tanks 18, 22a, 22b, respectively. When the corresponding display area is clicked with the mouse 152, its remaining amount is represented in bar-graph form. In the example of FIG. 5, a1 is clicked, with the result that the remaining amount of fuel in the fuel tank 18 is displayed. Moreover, a1 to a3 further display whether or not the fuel tanks 18, 22a, 22b have been installed. In the example of FIG. 5, it is shown that the fuel tank 22a has not been installed yet. The installation/uninstallation of the fuel tank 21a is detected by the microcomputer 21, which informs the microcomputer 171 of the result. The same holds true for the installation/uninstallation of the fuel tank 21b. The installation/uninstallation of the fuel tank 18 is detected by the microcomputer 171. While the difference between installation and uninstallation is represented by solid lines and dotted lines, this is illustrative and not restrictive. For instance, it may be represented by different display colors.

Furthermore, b indicates which one of the fuel tanks 18, 22a, 22b is supplying fuel to the DMFC cell stack 172 of the DMFC unit 17. In the example of FIG. 5, the fuel tank 18 is supplying fuel. Then, c1 to c3 are for switching the fuel tank to be used. In this state, when the display area of c3 is clicked with the mouse 152, the power supply management utility instructs the power supply controller 16 to switch the fuel tank in use from the fuel tank 18 to the fuel tank 22b. This instruction is transmitted from the power supply controller 16 to the micro-computer 171 of the DMFC unit 17 and further from the microcomputer 171 to the microcomputer 21 of the external fuel tank unit 2, with the result that the fuel in the fuel tank 22b starts to be supplied to the DMFC cell unit 172 of the DMFC unit 17. As a result, the power supply utility updates the display form so that b may represent the state after the switching.

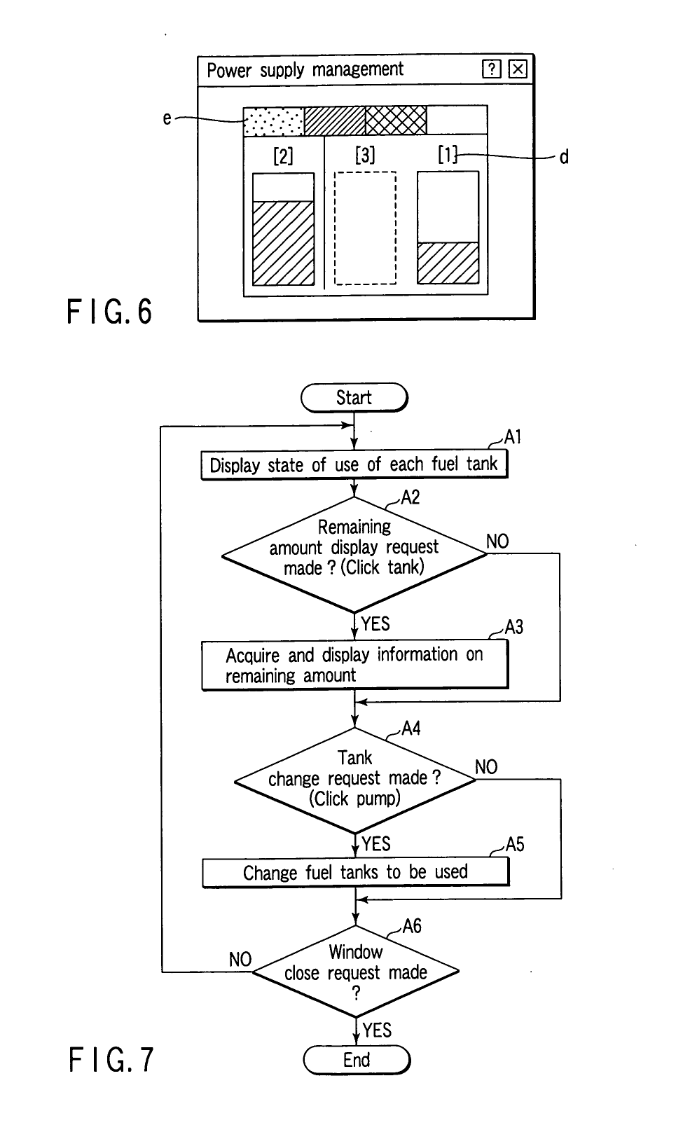

Furthermore, the power supply management utility displays a power supply management setting screen as shown in FIG. 6 on the LCD 141 according to the user's request. On the setting screen, it is possible to set not only the order in which the fuel tanks are used and the output level of the DMFC unit 17. In FIG. 6, d indicates an input area specifying the order in which the fuel tanks 18, 22a, 22b are used. In the example of FIG. 6, it is shown that the fuel tank 22b, fuel tank 18, and fuel tank 22a in that order of priority. Furthermore, e, which represents the present output level of the DMFC unit 17, is an indicator to change the output level. In the example of FIG. 6, the DMFC unit 17 is operating at level 3 among the four levels. Clicking the display area with the mouse 152 enables the output level to increase or decrease.

FIG. 7 is a flowchart to help explain the procedure for power supply control executed on the electronic apparatus 1.

The power supply management utility displays the state of use of each fuel tank on the LCD 141 according to the user's request (step A1). If on this display screen, a request to display the remaining amount of fuel in any one of the fuel tanks is made (YES in step A2), the power supply management utility acquires information on the remaining amount of fuel in the fuel tank and displays it (step A3). If a request to change fuel tanks is made (YES in step A4), the power supply utility executes the changing of fuel tanks to be-used (step A5).

The above processes are repeated until an instruction to close the screen is given. If the instruction is given (YES in step A6), displaying the screen on the LCE 141 is ended.

As described above, the electronic apparatus 1 can prevent an increase in the volume of the body when housing the DMFC unit 17 by enabling the fuel tank unit 2 to be externally connected as needed. Furthermore, the electronic apparatus 1 enables the fuel tanks 22a, 22b to be installed in and removed from freely the fuel tank unit 2, thereby making it possible to provide as much fuel as needed according to the situation.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

1. An electronic apparatus comprising:
a body;
a fuel cell which is built into the body;
a first fuel tank which holds fuel for the fuel cell built into the body; and
a second fuel tank which is removably provided to the body and which holds fuel for the fuel cell.

2. An electronic apparatus comprising:
a body;
a fuel cell which is housed in the body;
a housing unit which is provided in the body and which enables a first fuel tank holding fuel for the fuel cell to be housed in the body; and
a connector unit which is provided on the body and which enables a fuel tank unit capable of housing a second fuel tank holding fuel for the fuel cell to be connected to a housing for the body.

3. The electronic apparatus according to claim 2, further comprising:
a liquid supply unit configured to feed the fuel in the second fuel tank to the first fuel tank, when the fuel tank unit is installed.

4. The electronic apparatus according to claim 2, further comprising:
a liquid supply unit configured to feed the fuel in the second fuel tank to the fuel cell without letting the fuel pass through the first fuel tank, when the fuel tank unit is installed.

5. The electronic apparatus according to claim 2, further comprising:
a setting unit configured to set one of the first fuel tank and the second fuel tank to supply fuel to the fuel cell.

6. The electronic apparatus according to claim 2, further comprising:
a display provided on the body; and
a display control unit configured to display a state of use of each of the first fuel tank and the second fuel tank.

7. The electronic apparatus according to claim 2, wherein the fuel tank unit is installed on a side of the body.

8. The electronic apparatus according to claim 2, wherein the fuel tank unit is installed on a back of the body.

9. The electronic apparatus according to claim 2, wherein the fuel tank unit is installed on an underside of the body.

10. An electronic apparatus comprising:
a body;
a fuel cell which is housed in the body;
a housing unit which is provided in the body and which enables a fuel tank holding fuel for the fuel cell to be housed in the body; and
a connector unit which is provided on the body and which enables a fuel tank unit capable of housing the fuel tank to be connected to the body.

11. An electronic apparatus according to claim 10, further comprising:
a first acquisition unit configured to acquire data indicating a state of use of the fuel tank;
a second fuel tank which is removably provided to the body and which holds fuel for the fuel cell;
a second acquisition unit configured to acquire data indicating a state of use of the second fuel tank; and
a display control unit configured to display the states of use of the fuel tank and the second fuel tank acquired from the first acquisition unit and the second acquisition unit.

12. The electronic apparatus according to claim 11, wherein the data indicates the amount of fuel in the fuel tank or the second fuel tank and whether or not the fuel tank or the second fuel tank is in use.

13. A fuel tank unit comprising:
a connector for connecting with a body housing a fuel cell; and
a fuel tank slot capable of accommodating a fuel tank holding fuel for the fuel cell.

14. A method of controlling a power supply for an electronic apparatus having a fuel cell housed in its body, comprising:
acquiring data indicating a state of use of a first fuel tank holding fuel for the fuel cell housed in the body;
acquiring data indicating a state of use of a second fuel tank holding fuel for the fuel cell housed in a fuel tank unit connected to the surrounding wall of the body;
displaying on a screen the states of use of the first fuel tank and the second fuel tank shown in the respective data acquired; and
effecting various settings about the use of the first fuel tank and the second fuel tank according to operation on the displayed screen.
